(19) United States
(12) Patent Application Publication
(10) Pub. No.: US 2025/0264605 A1
(43) Pub. Date: Aug. 21, 2025

(54) COMPOSITION FOR RADAR TRANSMISSION COVER AND RADAR TRANSMISSION COVER MANUFACTURED USING SAME

(71) Applicant: AMOGREENTECH CO., LTD., Gimpo-si (KR)

(72) Inventor: Dong Hae KIM, Gimpo-si (KR)

(73) Assignee: AMOGREENTECH CO., LTD., Gimpo-si (KR)

(21) Appl. No.: 18/858,362

(22) PCT Filed: Apr. 20, 2023
(86) PCT No.: PCT/KR2023/005356

§ 371 Date: Dec. 19, 2024

(30) Foreign Application Priority Data
Apr. 20, 2022 (KR) 10-2022-0048711

(51) Int. Cl. G01S 13/931; C08K 3/34; C08K 7/14; G01S 7/02

(52) U.S. Cl. CPC G01S 13/931; C08K 3/346; C08K 7/14; G01S 7/027; C08K 2201/003; C08K 2201/005

(57) ABSTRACT

A composition for a radar transmission cover is provided. A composition for a radar transmission cover includes: a matrix ingredient including a thermoplastic resin; a reinforcement ingredient including glass fiber; and a shrinkage control ingredient including talc particles. Accordingly, the composition is advantageous for implementing a radar transmission cover having mechanical properties such as excellent flexural strength and flexural modulus. Also, as shrinkage characteristic differences in the forward/backward, upward/downward, and left/right directions occurring during injection molding are controlled, a radar transmission cover with a high level of smoothness can be manufactured.

### CROSS REFERENCE TO THE RELATED APPLICATIONS

This application is the national phase entry of International Application No. PCT/KR2023/005356, filed on Apr. 20, 2023, which is based upon and claims priority to South Korean Patent Application No. 10-2022-0048711, filed on Apr. 20, 2022, the entire contents of which are incorporated herein by reference.

### TECHNICAL FIELD

The present invention relates to a composition for a radar transmission cover and a radar transmission cover manufactured using the same.

### BACKGROUND

Recently, research on autonomous driving cars is being actively conducted in the global automobile industry. Among autonomous driving-related technologies, technologies such as ACC (Adaptive Cruise Control) and AEB (Autonomous Emergency Braking) are currently commercialized to improve driver convenience and safety. The core component of these technologies is an automotive radar, and in the case of long-distance front radar, it is located on the front bumper and is generally located inside a radiator grille, bumper grille or emblem at the center of the front of the vehicle.

Meanwhile, radiator grills are generally made of metal or plastic, and are re-plated with chrome so as to prevent corrosion from the external environment.

However, since metal has low radio wave transmission, it has a negative effect on the transmission and reception of radio waves by an automotive radar. Accordingly, attempts have been made to secure radio wave transmission by replacing some areas of the radiator grill with a separate radar transmission cover to ensure smooth transmission and reception of radio waves.

Radar transmission covers with radio transmission properties have been manufactured by mixing and injection-molding a reinforcement ingredient on fiber such as glass fiber to a matrix ingredient, which is usually a thermoplastic resin, in order to supplement mechanical strength such as flexural strength. In the case of such conventional radar transmission cover compositions, the difference in shrinkage rates between materials and the reinforcement ingredient on the fiber with an aspect ratio as the molten material flows into a mold during injection molding can be aligned in a direction in which the material flows, and as a result, the injection-molded radar transmission cover may experience uneven shrinkage in the forward/backward, left/right and upward/downward directions, which may cause excessive shrinkage in a direction perpendicular to the material flow direction. As a result, there is a problem in that the smoothness of the radar transmission cover is significantly reduced.

In addition, the radar transmission cover may have a plating layer formed on one side after being injected, or may undergo a follow-up process to remove part of the formed plating layer by etching. When the content of the reinforcement ingredient on the fiber increases, the plating and etching properties are deteriorated compared to when the reinforcement ingredient on fiber is not included, and thus, there are problems in that the man-hours and manufacturing costs increase and the manufacturing time is extended, such as performing an activation process on the surface of the radar transmission cover separately or performing an etching process after a swelling process after plating.

Therefore, there is an urgent need to research a radar transmission cover that maintains mechanical strength at the conventional level and improves smoothness by controlling forward/backward, left/right and upward/downward shrinkage characteristics during injection molding.

### SUMMARY

### Technical Problem

The present invention has been devised in consideration of the above points, and has an object to provide a composition for a radar transmission cover that is capable of manufacturing a radar transmission cover with a high level of smoothness by controlling differences in forward/backward, upward/downward and left/right shrinkage characteristics that occur during injection molding while possessing high mechanical strength, and a radar transmission cover manufactured by using the same.

### Technical Solution

In order to solve the above-described problems, the present invention provides a composition for a radar transmission cover, including a matrix ingredient including a thermoplastic resin, a reinforcement ingredient including glass fiber and a shrinkage control ingredient including talc particles.

According to an embodiment of the present invention, the thermoplastic resin may contain at least one selected from the group consisting of polycarbonate (PC), polyethylene terephthalate (PET), polybutylene terephthalate (PBT), polyamide 6 (PA 6), polyamide 66 (PA 66), polypropylene, polyethylene, polyimide (PI), liquid crystal polymer (LCP), polyphenylene sulfide (PPS), acrylonitrile butadiene styrene (ABS), polyacetal (POM), polyvinyl chloride (PVC), polystyrene (PS), polymethyl methacrylate (PMMA) and modified polyphenylene oxide (mPPO).

In addition, the glass fiber may have a diameter of 8 to 15 μm and a length of 3 to 8 mm.

In addition, the talc particles may have an average particle diameter of 15 μm or less.

In addition, the reinforcement ingredient may be contained in an amount of 15 to 35 wt % of the total weight of the composition, and the shrinkage control ingredient may be contained in an amount of 5 to 25 wt % of the total weight of the composition.

In addition, the reinforcement ingredient may be contained in an amount of 15 to 25 wt % of the total weight of the composition, and the shrinkage control ingredient may be contained in an amount of 5 to 15 wt % of the total weight of the composition.

In addition, the talc particles may contain 97 to 99 wt % of first talc particles having an average particle size of 10 to 15 μm and 1 to 3 wt % of second talc particles having an average particle size of 2.5 to 6.5 μm.

In addition, a difference in shrinkage rates in the machine direction (MD) and transverse direction (TD) of an injection-molded product implemented by injection-molding the composition for a radar transmission cover may satisfy 3% or less, and more preferably, 1% or less.

In addition, a shrinkage rate in the MD direction and a shrinkage rate in the TD direction may be each 2.5% or less, and more preferably, each less than 1.5%.

In addition, the present invention provides a radar transmission cover, including a cover member formed by injection-molding the composition for a radar transmission cover according to the present invention.

According to an embodiment of the present invention, the radar transmission cover may include a body in which an upper cover member and a lower cover member, each of which is injected with the composition for a radar transmission cover, are coupled to form an integrated body; and a metal layer provided on a surface of the upper cover member or the lower cover member so as to be positioned between the upper cover member and the lower cover member.

In addition, the metal layer may be formed through plating or deposition.

### Advantageous Effects

The composition for a radar transmission cover according to the present invention is advantageous for implementing a radar transmission cover with mechanical properties such as excellent flexural strength and flexural modulus. In addition, as the differences in forward/backward, upward/downward and left/right shrinkage characteristics that occur during injection molding are controlled, it is possible to manufacture a radar transmission cover with a high level of smoothness.

### BRIEF DESCRIPTION OF THE DRAWINGS

FIGS. 1 to 4 are mimetic diagrams showing shrinkage characteristics during injection molding. FIG. 1 is a mimetic diagram for a matrix ingredient alone, FIG. 2 is a mimetic diagram for a case where a matrix ingredient and a reinforcement ingredient on fiber which is glass fiber are mixed, FIG. 3 is a mimetic diagram for a case where a matrix ingredient and a shrinkage control ingredient in the form of talc particles are mixed, and FIG. 4 is a mimetic diagram for a case where the matrix ingredient, the fiber reinforcement ingredient on fiber which is glass fiber and the shrinkage control ingredient in the form of talc particles are mixed.

FIG. 5 is a cross-sectional mimetic diagram of a radar transmission cover according to an embodiment of the present invention.

### DETAILED DESCRIPTION OF THE EMBODIMENTS

Hereinafter, with reference to the attached drawings, embodiments of the present invention will be described in detail so that those skilled in the art can easily practice the present invention. The present invention may be implemented in many different forms and is not limited to the embodiments described herein. In order to clearly explain the present invention in the drawings, parts that are not related to the description are omitted, and the same or similar components are assigned the same reference numerals throughout the specification.

The composition for a radar transmission cover according to an embodiment of the present invention includes a matrix ingredient including a thermoplastic resin, a fibrous reinforcement ingredient including glass fiber and a shrinkage control ingredient including talc particles.

The matrix ingredient is a component that forms the body of a radar transmission cover and includes a thermoplastic resin, and the thermoplastic resin may be any resin used in the preparation of a known composition for a radar transmission cover without limitation. Additionally, in addition to the thermoplastic resin, it may further include a thermosetting resin used in the preparation of a known composition for a radar transmission cover.

Examples of the thermoplastic resin may include at least one selected from the group consisting of polycarbonate (PC), polyethylene terephthalate (PET), polybutylene terephthalate (PBT), polyamide 6 (PA 6), polyamide 66 (PA 66), polypropylene, polyethylene, polyimide (PI), liquid crystal polymer (LCP), polyphenylene sulfide (PPS), acrylonitrile butadiene styrene (ABS), polyacetal (POM), polyvinyl chloride (PVC), polystyrene (PS), polymethyl methacrylate (PMMA) and modified polyphenylene oxide (mPPO). Preferably, the thermoplastic resin may contain at least one of polycarbonate, polyamide 66 and polybutylene terephthalate (PBT), and when polycarbonate is included, it may be advantageous to implement an injection-molded product with improved smoothness through a shrinkage control ingredient including the talc described below.

In addition, the reinforcement ingredient is a component for improving the mechanical properties of the molded body, and includes a fibrous component including glass fiber, and in addition to glass fiber, it may further contain a known fibrous reinforcement ingredient contained in the composition for a radar transmission cover.

For the glass fiber, any known glass fiber composition employed in a composition for a radar transmission cover may be adopted without limitation. By adjusting the composition and content of glass fiber, the dielectric constant and dielectric loss characteristics may be achieved at the desired level. As an example, the glass fiber may contain at least one element oxide selected from the group consisting of silicon, boron, aluminum, calcium, magnesium, lithium, sodium, potassium, titanium and iron. Specifically, the glass fiber may include 55 to 75 wt % of SiO₂ and 15 to 25 wt % of B₂O₃; and 1 to 25 wt % of other oxides, and preferably, 60 to 75 wt % of SiO₂ and 16 to 24 wt % of B₂O₃. Meanwhile, other oxides may include one or more ingredients of Al₂O₃, CaO, MgO, Li₂O, Na₂O, K₂O, TiO₂ and Fe₂O₃.

For the glass fiber, for example, those with an aspect ratio of 300 or more, which is the ratio of the major axis that is the length, and the minor axis that is the diameter may be used, and preferably, the glass fiber has a diameter of 8 to 15 μm and a length of 3 to 8 mm. Through this, it may be advantageous for achieving the object of the present invention, such as improving mechanical properties.

In addition, the glass fiber may have a polygonal cross-section such as circular, oval or rectangular shape, and the present invention is not particularly limited thereto.

In addition, for the glass fiber, those that are surface-treated with a silane-based compound such as epoxysilane or an olefin such as polyethylene to improve dispersibility within the matrix ingredient, flowability and compatibility between different materials may be used.

Meanwhile, the reinforcement ingredient may further contain reinforcement ingredients in the form of different types of fibers in addition to glass fiber. For example, the heterogeneous fibrous reinforcement ingredient may be carbon fiber, synthetic resin fiber, cellulose-based fiber and the like, and the present invention is not particularly limited thereto.

The reinforcement ingredient may be contained in an amount of 15 to 35 wt % of the total weight of the composition, and more preferably in an amount of 15 to 25 wt %. If the reinforcement ingredient is contained in an amount of less than 15 wt % of the total weight of the composition, the mechanical properties may be reduced, and particularly, there is a risk that the flexural modulus of elasticity may be greatly reduced. In addition, if the reinforcement ingredient exceeds 35 wt %, there is a risk of excessive shrinkage in the TD direction perpendicular to the MD direction, which is a direction in which the molten composition flows through an injection port during injection, and as the content of talc particles, which will be described below, relatively decreases, it may be difficult to control hypercontraction in the TD direction. In addition, there is a risk that the mechanical properties may decrease or the surface quality may deteriorate as the content of the matrix ingredient that forms the body decreases. In addition, excessive fibrous reinforcement ingredients reduce the plating and etching properties of an injected surface, thereby making it difficult to form a metal layer on the injected surface, or requiring a separate process to facilitate formation and etching.

Next, the shrinkage control ingredient including talc will be described.

The conventionally disclosed composition for a radar transmission cover attempted to achieve mechanical properties through glass fiber, but during injection molding, the longitudinal direction of the glass fiber was aligned in the injected MD direction, which resulted in excessive shrinkage in the TD direction, and since the shrinkage characteristics also differed depending on a location in the thickness direction, there was a high frequency of mass-producing injection-molded products with poor smoothness. However, when talc is used as a shrinkage control ingredient, talc acts as a nucleating agent and exerts a rapid cooling and shrinkage control effect, thereby suppressing shrinkage in the TD direction caused by glass fiber and conversely reducing tension in the MD direction, and as a result, it may be more advantageous for implementing injection-molded products with a high level of smoothness by reducing the difference in shrinkage rates in the TD and MD directions.

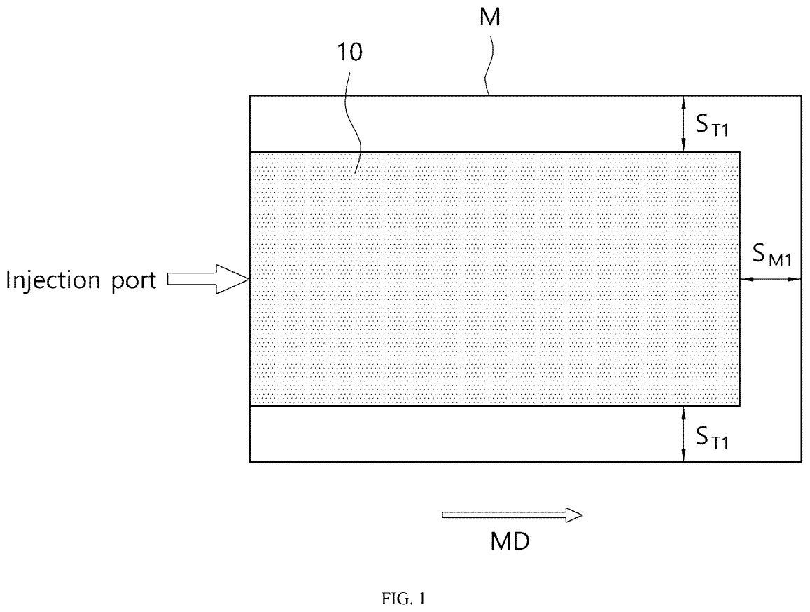

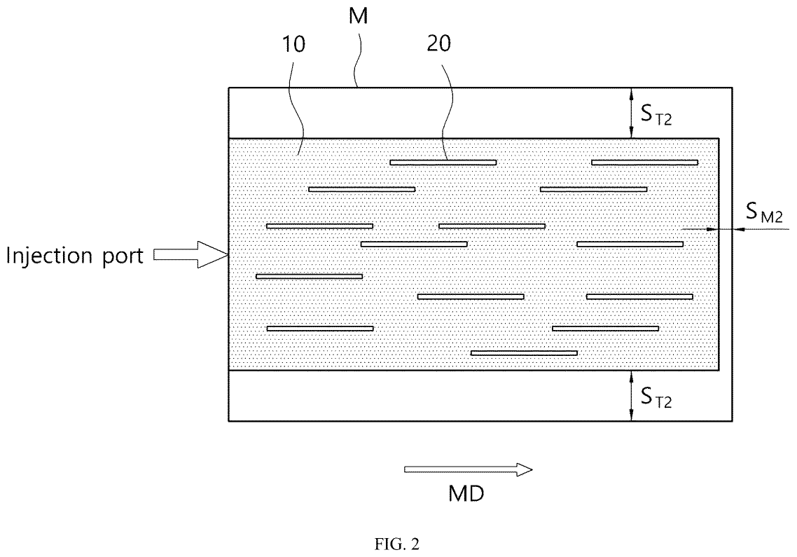

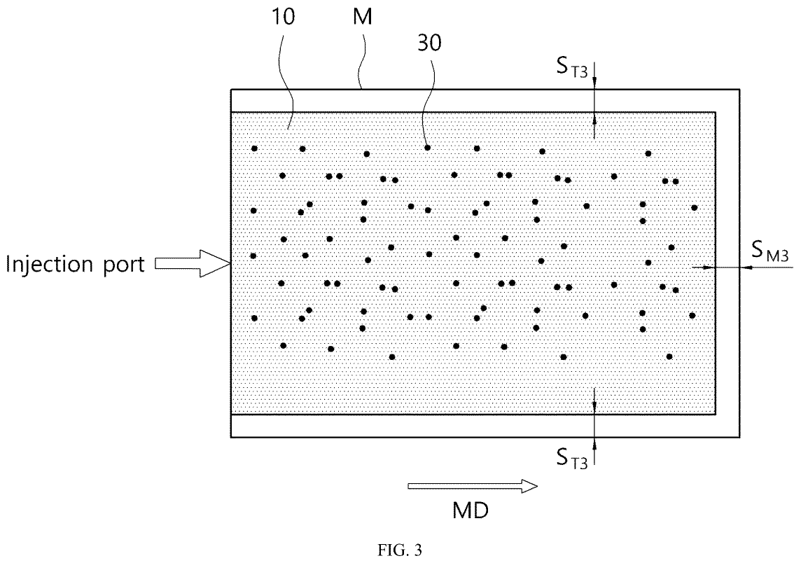

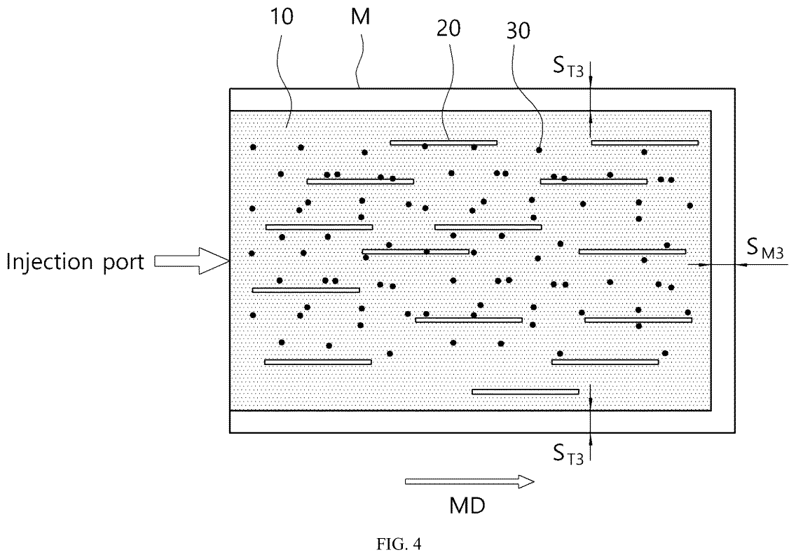

When explaining this with reference to FIGS. 1 to 4, when only a matrix ingredient 10 was injected as shown in FIG. 1 and shrinkage occurred by Sun in the MD direction and S_{T1} in the TD direction, if the matrix component 10 contained a fibrous reinforcing component 20 that was glass fiber, as shown in FIG. 2, the shrinkage in the MD direction S_{M2} occurred less than the shrinkage in the MD direction Syn in FIG. 1, whereas the shrinkage in the TD direction S_{T2} occurred much more than the shrinkage in the TD direction Sri in FIG. 1. However, as shown in FIG. 3, when only a shrinkage control ingredient 30, which was talc in the form of particles rather than fibers, was included, both shrinkages S_{M3}. S_{T3} in the MD and TD directions could be reduced compared to FIG. 1. Meanwhile, as shown in FIG. 3, even when the shrinkage control ingredient 30, which was talc, contained a fibrous reinforcement ingredient 20, which was glass fiber as shown in FIG. 4, it can be confirmed that by controlling the shrinkage characteristics due to the fibrous reinforcing component 20, both shrinkages S_{M4}, S_{T4} in the MD direction and TD direction could be controlled to levels similar to those in FIG. 3.

Additionally, in addition to the shrinkage control effect described above, talc may further strengthen mechanical properties and improve plating and etching properties for plating a metal layer on the surface of an injected cover member.

Meanwhile, ingredients other than talc, such as silica, mica, calcium carbide and titanium dioxide, may not be suitable as shrinkage control ingredients, and it may be difficult to exhibit a shrinkage characteristic control effect at the level of talc. Accordingly, even when these components are further included in addition to talc, it may be advantageous to achieve the object of the present invention when the shrinkage control ingredient contains at least 80 wt % of talc, more preferably at least 90 wt %, and even more preferably at least 95 wt %.

The talc may be particles with an average particle diameter of 15 μm or less. Preferably, the talc may contain 97 to 99 wt % of first talc particles having an average particle diameter of 10 to 15 μm and 1 to 3 wt % of second talc particles having an average particle diameter of 2.5 to 6.5 μm, and through this, it is possible to exhibit an elevated effect in controlling the shrinkage characteristics, and at the same time, it may be more advantageous to achieve the object of the present invention.

In addition, the shrinkage control ingredient including the talc may be contained in an amount of 5 to 25 wt %, more preferably, 5 to 15 wt %, and even more preferably, 10 to 15 wt % of the total weight of the composition. If the shrinkage control ingredient including talc is contained in an amount of less than 5 wt %, it may be difficult to sufficiently control the shrinkage characteristics in the TD direction due to the glass fiber. Additionally, the effect of improving plating properties and supplementing mechanical properties may be minimal. In addition, if talc exceeds 25 wt %, the content of glass fiber may be relatively reduced, which may deteriorate mechanical properties. Additionally, if the content of matrix ingredients other than glass ingredients is reduced, the surface quality of the injection-molded product may deteriorate, and even in this case, there is a risk that the mechanical properties will also deteriorate.

In addition, the composition for a radar transmission cover described above may further include known additives contained in known compositions for a radar transmission cover. The additives may be flame retardants, antioxidants, UV stabilizers, lubricants, colorants and the like, and the present invention is not particularly limited thereto.

In addition, the composition for a radar transmission cover may be prepared in the form of a pellet, and through this, it has the advantage of allowing the composition to be more easily used during molding such as injection.

Meanwhile, an injection-molded product obtained by injecting the composition for a radar transmission cover according to an embodiment of the present invention described above may satisfy a difference in shrinkage rates in the MD and TD directions of 3% or less, and more preferably, 1% or less. In addition, the shrinkage rate in the MD direction and the shrinkage rate in the TD direction may each satisfy 2.5% or less, and more preferably, 1.5% or less, which is advantageous for mass production of injection-molded products with excellent smoothness. In this case, the shrinkage rate is expressed as a percentage of the degree of shrinkage after measuring the lengths of the injection-molded product in the MD and TD directions based on the size of the mold in the MD and TD directions during injection.

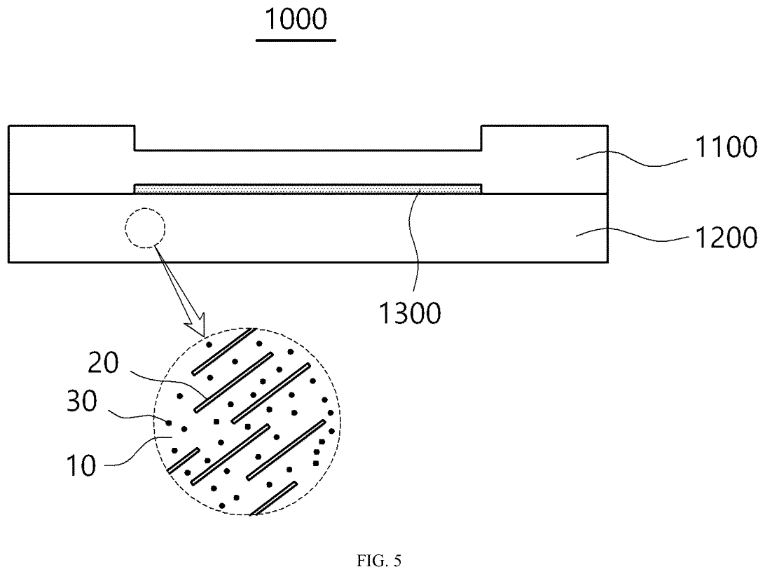

In addition, as shown in FIG. 5, a radar transmission cover 1000 may be implemented through cover members 1100, 1200 formed by injecting the composition for a radar transmission cover according to an embodiment of the present invention as described above.

In this case, the radar transmission cover 1000 may include a body in which an upper cover member 1100 and a lower cover member 1200, each of which is injected with a composition for a radar transmission cover, are coupled to form an integrated body, and a metal layer 1300 provided on a surface of the upper cover member 1100 or the lower cover member 1200 to be positioned between the upper cover member 1100 or the lower cover member 120.

The upper cover member 1100 and the lower cover member 1200 may be any shape or size of a known radar transmission cover without limitation, and the present invention is not particularly limited thereto. In addition, FIG. 5 shows that one body is formed through the upper cover member 1100 and the lower cover member 1200, but it should be noted that it may be injected to form one body during injection. In addition, the coupling between the upper cover member 1100 and the lower cover member 1200 may be achieved by coupling through shape/structural coupling elements such as a forced fit, joining through welding, and/or fastening or bonding through a separately known fastener or adhesive member.

Meanwhile, in the case of a vehicle radar, as described above, it is located inside a radiator grille or emblem at the front center of a vehicle, and it means that the radar transmission cover may also be located on a side of the radiator grille or emblem corresponding to the radar. In vehicles, radiator grills or emblems are parts with added design elements and are made of shiny metal or a material with a metallic feel. When installing a radar transmission cover on these parts, there is a problem that greatly reduces the aesthetics of the design. Therefore, a metal layer 1300 may be included in one area of the radar transmission cover to minimize interference with radar transmission while offsetting this as much as possible. The metal layer 1300 may use a known metal layer material provided in a radar transmission cover, and may be indium or chromium, for example. Additionally, the metal layer 1300 may be formed through deposition or plating by considering the material. In addition, the metal layer 1300 may be formed to be located between the upper cover member 1100 and the lower cover member 1200 in terms of durability, and it may be formed on one surface of the upper cover member 1100 and/or the lower cover member 1200. In this case, the metal layer 1300 may be formed only on a portion of one surface of the upper cover member 1100 and/or the lower cover member 1200 in order to minimize interference with the transmission of radar radio waves. Meanwhile, in order to form the metal layer 1300 only on a portion of one surface of the upper cover member 1100 and/or the lower cover member 1200, the metal layer 1300 may be deposited or plated on the entire surface, and then, the metal layer formed on a portion of the surface other than the intended formation portion may be removed through an etching process. The etching process may be removed through a known method by considering the material of the formed metal layer 1300, and the present invention is not particularly limited thereto.

### MODES OF THE INVENTION

The present invention will be described in more detail through the following examples, but the following examples do not limit the scope of the present invention, and should be interpreted to aid understanding of the present invention.

### Experimental Example

The following physical properties were measured for the pellet-type radar transmission cover composition prepared through the examples below.

### 1. Tensile Strength and Tensile Elongation

Tensile strength and tensile elongation were measured according to ISO 527.

### 2. Flexural Strength

Flexural strength was measured according to ISO 178.

### 3. Flexural Modulus of Elasticity

Flexural strength was measured according to ISO 178.

### 4. Impact Strength (IZOD)

IZOD was measured based on ISO 180. In this case, the thickness of the measured specimen was 4.0 mm.

### 5. Shrinkage Rate

After injecting pellets in the usual manner through an injection device, the lengths of an injection-molded product were measured in the MD and TD directions, which are directions in which the molten composition was injected into the 100 mm×100 mm mold, and the shrinkage rate was calculated according to the formula below. Herein, the reference value refers to the size of a mold in MD and TD directions.

Shrinkage rate (%)=[(Reference value (mm)−Length of injection-molded product (mm))/Reference value (mm)]×100

### Examples 1 to 4

After preparing polybutylene terephthalate as a matrix ingredient, glass fiber with a diameter of 10 μm and a length of 4 mm as a fibrous reinforcement ingredient, 98 wt % of first talc particles with an average particle diameter of 11 μm, and 2 wt % of second talc particles with an average particle diameter of 3.5 μm as shrinkage control ingredients, respectively, these were mixed and stirred at mixing ratios according to Table 1 below to prepare compositions for radar transmission covers in the form of pellets.

### Comparative Example 1

A composition for a radar transmission cover in the form of a pellet was prepared in the same manner as in Example 1, except that it was mixed and stirred at a mixing ratio without talc as shown in Table 1 below.

TABLE 1

| | | | | | | Comparative |
|---|---|---|---|---|---|---|
| | | Example 1 | Example 2 | Example 3 | Example 4 | Example 1 |
| PBT (wt %) | | 70 | 70 | 70 | 65 | 70 |
| Talc (wt %) | | 5 | 10 | 15 | 10 | 0 |
| Glass Fiber (wt %) | | 25 | 20 | 15 | 25 | 30 |
| Impact Strength (IZOD) | | 3.86 | 3.86 | 3.59 | 4.7 | 5.5 |
| (kgf · cm/cm) | | | | | | |
| Tensile Strength (kg/cm²) | | 86 | 78 | 69 | 78 | 84 |
| Tensile Elongation (%) | | 5.47 | 5.31 | 5.1 | 4.75 | 4.98 |
| Flexural Strength (kg/cm²) | | 123 | 110 | 99 | 109 | 130 |
| Flexural Modulus (kg/cm²) | | 7,973 | 7,496 | 6,793 | 8,631 | 8,351 |
| Shrinkage Rate | MD | 1.45 | 1.48 | 1.79 | 1.31 | 0.55 |
| (%) | TD | 2.23 | 2.16 | 2.38 | 1.9 | 1.50 |
| | TD-MD | 0.78 | 0.68 | 0.59 | 0.59 | 1.45 |

As can be confirmed in Table 1, the compositions for radar transmission covers according to Examples 1 to 4 resulted in excellent control of shrinkage characteristics, with shrinkage rates in the MD and TD directions of 3% or less each during injection, and it can be confirmed that the difference in shrinkage rates in the MD and TD directions was also excellently controlled to 1% or less. In contrast, in Comparative Example 1, the difference in shrinkage rates in the MD and TD directions exceeded 1%, and the implemented injection-molded product was bent. <Examples 5 to 7>

Polycarbonate was prepared as a matrix ingredient. In addition, the same talc and glass fiber as those used in Examples 1 to 4 were prepared, and these were mixed and stirred at a mixing ratio according to Table 2 below to prepare compositions for radar transmission covers in the form of pellets.

### Comparative Examples 2 to 3

Compositions for radar transmission covers in the form of pellets were prepared in the same manner as in Example 5, except that these were mixed and stirred at mixing ratios without glass fiber as shown in Table 2 below.

TABLE 2

| | | | | | Comparative | Comparative |
|---|---|---|---|---|---|---|
| | | Example 5 | Example 6 | Example 7 | Example 2 | Example 3 |
| PC (wt %) | | 70 | 70 | 70 | 80 | 70 |
| Talc (wt %) | | 5 | 10 | 15 | 20 | 30 |
| Glass Fiber (wt %) | | 25 | 20 | 15 | 0 | 0 |
| Impact Strength (IZOD) | | 6 | 4.7 | 3.73 | 1.52 | 1.49 |
| (kgf · cm/cm) | | | | | | |
| Tensile Strength (kg/cm²) | | 70 | 69 | 71 | 16 | 20 |
| Tensile Elongation (%) | | 3.86 | 3.95 | 4.46 | 1.25 | 1.24 |
| Flexural Strength (kg/cm²) | | 105 | 100 | 90 | 24 | 30 |
| Flexural Modulus (kg/cm²) | | 7,948 | 7,695 | 6,986 | 4,201 | 4,100 |
| Shrinkage Rate | MD | 0.22 | 0.39 | 0.43 | 0.61 | 0.50 |
| (%) | TD | 0.4 | 0.48 | 0.43 | 0.76 | 0.58 |
| | TD-MD | −0.18 | 0.09 | 0 | 0.15 | 0.07 |

As can be confirmed in Table 2, when it was injected through the compositions for radar transmission covers according to Examples 5 to 7, they had excellent control over shrinkage characteristics, with shrinkage rates in the MD and TD directions being each 1% or less, and it can be confirmed that the difference in shrinkage rates in the MD and TD directions was excellently controlled to 1% or less. On the other hand, in the case of Comparative Examples 2 and 3 that did not include glass fiber, the difference in shrinkage rates in the TD and MD directions was small, and thus, bending did not occur in the implemented injection-molded product, but it can be seen that strength properties, such as flexural strength, flexural modulus, tensile elongation and tensile strength, were significantly reduced.

Although one embodiment of the present invention has been described above, the spirit of the present invention is not limited to the embodiment presented in the present specification, and those skilled in the art who understand the spirit of the present invention will be able to easily suggest other embodiments by modifying, changing, deleting or adding components within the scope of the same spirit, but this will also fall within the spirit of the present invention.

What is claimed is:

1. A composition for a radar transmission cover, comprising a matrix ingredient comprising a thermoplastic resin, a reinforcement ingredient comprising a glass fiber, and a shrinkage control ingredient comprising talc particles.

2. The composition of claim 1, wherein the thermoplastic resin contains at least one selected from the group consisting of polycarbonate (PC), polyethylene terephthalate (PET), polybutylene terephthalate (PBT), polyamide 6 (PA 6), polyamide 66 (PA 66), polypropylene, polyethylene, polyimide (PI), liquid crystal polymer (LCP), polyphenylene sulfide (PPS), acrylonitrile butadiene styrene (ABS), polyacetal (POM), polyvinyl chloride (PVC), polystyrene (PS), polymethyl methacrylate (PMMA), and modified polyphenylene oxide (mPPO).

3. The composition of claim 1, wherein the glass fiber has a diameter of 8 to 15 μm and a length of 3 to 8 mm.

4. The composition of claim 1, wherein the talc particles have an average particle diameter of 15 μm or less.

5. The composition of claim 1, wherein the reinforcement ingredient is contained in an amount of 15 to 35 wt % of a total weight of the composition, and the shrinkage control ingredient is contained in an amount of 5 to 25 wt % of the total weight of the composition.

6. The composition of claim 5, wherein the reinforcement ingredient is contained in an amount of 15 to 25 wt % of the total weight of the composition, and the shrinkage control ingredient is contained in an amount of 5 to 15 wt % of the total weight of the composition.

7. The composition of claim 1, wherein the talc particles contain 97 to 99 wt % of first talc particles having an average particle size of 10 to 15 μm and 1 to 3 wt % of second talc particles having an average particle size of 2.5 to 6.5 μm.

8. The composition of claim 1, wherein a difference in a shrinkage rate in a machine direction (MD) and a shrinkage rate in a transverse direction (TD) of an injection-molded product implemented by injection-molding the composition for the radar transmission cover is 3% or less.

9. The composition of claim 8, wherein the difference in the shrinkage rate in the MD and the shrinkage rate in the TD is 1% or less.

10. The composition of claim 8, wherein the shrinkage rate in the MD and the shrinkage rate in the TD are each 2.5% or less.

11. A radar transmission cover, comprising a cover member formed by injection-molding the composition of claim 1.

12. The radar transmission cover of claim 11, further comprising:
a body, wherein an upper cover member and a lower cover member are coupled to form an integrated body in the body, and each of the upper cover member and the lower cover member is injected with the composition for the radar transmission cover; and
a metal layer provided on a surface of the upper cover member or the lower cover member to be positioned between the upper cover member and the lower cover member.

13. The radar transmission cover of claim 12, wherein the metal layer is formed through plating or deposition.
